(19) United States
(12) Patent Application Publication
(10) Pub. No.: US 2022/0155471 A1
(43) Pub. Date: May 19, 2022

(54) TIME OF FLIGHT POSITRON EMISSION TOMOGRAPHY WITH DIRECT CONVERSION SEMICONDUCTOR CRYSTAL DETECTORS

(71) Applicant: KONINKLIJKE PHILIPS N.V., EINDHOVEN (NL)

(72) Inventor: Ira Micah BLEVIS, Zichron Yaakov (IL)

(21) Appl. No.: 17/442,324

(22) PCT Filed: Mar. 17, 2020
(86) PCT No.: PCT/EP2020/057261

§ 371 Date: Sep. 23, 2021

Related U.S. Application Data
(60) Provisional application No. 62/823,815, filed on Mar. 26, 2019.

(51) Int. Cl. G01T 1/29

(52) U.S. Cl. CPC G01T 1/2985; G01T 1/2964

(57) ABSTRACT

A time of flight positron emission tomography (TOF PET) detector comprises a direct conversion semiconductor crystal (e.g. CZT), cathode and anode disposed on respective first and opposite second faces of the crystal, and a timing circuit operatively connected to generate a trigger signal in response to absorption of a 511 keV gamma ray by the direct conversion semiconductor crystal. The timing circuit generates the trigger signal with jitter of 500 picoseconds or lower. One or both of the cathode and/or anode is a blocking electrode. In some embodiments, the cathode is a single continuous electrode, the timing circuit is operatively connected with the cathode, the anode comprises an array of electrode pixels disposed on the second face of the direct conversion semiconductor crystal, and a sense circuit is operatively connected with the electrode pixels of the anode. TOF PET scanners including such detectors are also disclosed.

### FIELD

The following relates generally to the positron emission tomography (PET) imaging arts, timestamped radiation detector arts, time-of-flight (TOF) PET imaging arts, PET image reconstruction arts, and related arts.

### BACKGROUND

In radiology, high energy radiations and particles (e.g. X-rays, gamma rays, or so forth) are detected, and radiology images of a subject are reconstructed based on the detected radiation. In computed tomography (CT) imaging, an X-ray tube and an opposing X-ray detector array rotate in unison around an imaging subject (e.g. a medical patient) such that the detector receives X-rays from the X-ray tube after passing through the patient. Based on the detected X-ray intensities as a function of angular position around the patient, a CT image of the patient can be reconstructed. Other X-ray imaging techniques operate similarly, with or without rotation or other movement of the X-ray tube respective to the patient. Using a static X-ray tube produces a two-dimensional image of the patient. If a solid state X-ray detector array is employed, then the static technique is sometimes referred to as digital radiography (DR).

Single photon emission computed tomography (SPECT) employs a gamma camera with one, two, or more radiation detector heads robotically mounted to move around the patient. In SPECT, the patient is administered a radiopharmaceutical, and the detector heads detect radioactive particles emitted by the administered radiopharmaceutical. The detector heads have radiation collimators, such as lead-based honeycomb collimators, which ensure that each radiation detection event corresponds to a radioactive decay event located along a line or small-angle conical region. The spatial definition provided by the collimator allows for computer reconstruction of an image based on the acquired radiation detection events.

Positron emission tomography (PET) employs one or more stationary rings of radiation detectors, and the patient is administered a radiopharmaceutical that emits positrons which rapidly combine with neighboring electrons in electron-positron annihilation events. PET relies upon a specific property of these annihilation events: namely, that they typically result in two 511 keV gamma rays being emitted in opposite directions (due to conservation of momentum). This geometric property of the 511 keV gamma ray emissions enables association of two coincident 511 keV detections with a line of response (LOR) connecting the two detection events. Detection events are filtered by particle energy to isolate 511 keV detection events, and coincidence detection circuitry associates pairs of 511 keV detection events occurring within a narrow coincidence time window. Each such pair has an associated LOR connecting the events of the pair. The spatial definition provided by the associated LORs enables reconstruction of the temporally coincident 511 keV detection event pairs into a PET image of the patient.

Time-of-flight (TOF) PET is a variant of the PET imaging technique. In TOF PET, the radiation detectors are sufficiently fast to provide some spatial localization of the sourcing positron-electron annihilation event along the LOR associated with a temporally coincident 511 keV detection event pair. This can be qualitatively conceptualized by recognizing that, if the detectors have sufficient time resolution, then the detector that is closer to the positron-electron annihilation event should generate the first 511 keV detection event of the pair; while the detector that is further from the positron-electron annihilation event should detect the second 511 keV detection event of the pair at some later time. (If the event is equidistant from both detectors, then they should detect the events of the pair simultaneously within the temporal resolution). Some existing TOF PET imaging systems employ detectors with timing resolution of 200-300 picoseconds, corresponding to a spatial resolution along the LOR of around 6-9 cm. The spatial localization along the LOR can provide substantially improved the image quality as compared with conventional (i.e. non-TOF) PET.

Radiation detectors for radiology imaging can be classified as scintillator-based detectors, or direct conversion detectors. The former employ two components: a scintillator crystal which generates a scintillation (i.e. a flash of light) in response to absorbing an X-ray or gamma ray; and photodetectors optically coupled with the scintillator to detect the scintillation. Direct conversion detectors, on the other hand, absorb the X-ray or gamma ray and produce an electric pulse directly. Cadmium zinc telluride (CZT) is a known direct conversion radiation detector material, which can be electrically biased to generate an electrical current pulse in response to absorbing an X-ray or gamma ray. However, use of CZT detectors or other direct conversion detectors in TOF PET is problematic due to the requisite timing resolution, and TOF PET scanners currently use scintillator-based detectors with 200-300 picosecond resolution.

The following discloses certain improvements.

### SUMMARY

In some non-limiting illustrative embodiments disclosed herein, a time of flight positron emission tomography (TOF PET) detector comprises: a direct conversion semiconductor crystal; a cathode disposed on a first face of the direct conversion semiconductor crystal; an anode disposed on a second face of the direct conversion semiconductor crystal opposite from the first face; and a timing circuit operatively connected to generate a trigger signal in response to absorption of a 511 keV gamma ray by the direct conversion semiconductor crystal. The timing circuit generates the trigger signal with jitter of 500 picoseconds or lower. In some embodiments, a plurality of said direct conversion semiconductor crystals are arranged with each neighboring pair of direct conversion semiconductor crystals positioned with one of (i) their respective cathodes facing each other or (ii) their respective anodes facing each other. In some embodiments, one or both of the cathode and/or anode comprises a blocking electrode. In some embodiments, the cathode comprises at least one metal layer and at least one dielectric layer which is interposed between the at least one metal layer of the cathode and the first side of the direct conversion semiconductor crystal, and/or similarly the anode comprises at least one metal layer and at least one dielectric layer which is interposed between the at least one metal layer of the anode and the second side of the direct conversion semiconductor crystal. In some embodiments, the cathode is a single continuous electrode, the timing circuit is operatively connected with the cathode, the anode comprises an array of electrode pixels disposed on the second face of the direct conversion semiconductor crystal, and a sense circuit (which is to be understood as encompassing embodiments with multiple sense circuits) is operatively connected with the electrode pixels of the anode to detect an electric pulse generated by the direct conversion semiconductor crystal in response to absorption of a 511 keV gamma ray by the direct conversion semiconductor crystal.

In some non-limiting illustrative embodiments disclosed herein, a TOF PET scanner comprises one or more PET detector rings comprising TOF PET detectors as set forth in the immediately preceding paragraph, and an electronic processor programmed to generate TOF PET coincidence events with time of flight localization determined based on the trigger signals generated by the timing circuits of the TOF PET detectors. The electronic processor may optionally be further programmed to generate a TOF PET image by accumulating the TOF PET coincidence events by direct three-dimensional (3D) data accumulation and without performing an iterative image reconstruction and without performing backprojection.

In some non-limiting illustrative embodiments disclosed herein, a TOF PET detection method is disclosed, comprising: detecting 511 keV gamma rays using a direct conversion semiconductor crystal biased via a cathode disposed on a first face of the direct conversion semiconductor crystal and an anode disposed on a second face of the direct conversion semiconductor crystal opposite from the first face; and generating trigger signals having jitter of 500 picoseconds or lower corresponding to the detected 511 keV gamma rays using a timing circuit operatively connected with the direct conversion semiconductor crystal. The direct conversion semiconductor crystal may, for example, be a cadmium telluride (CdTe) or cadmium zinc telluride (CZT) crystal.

In some non-limiting illustrative embodiments disclosed herein, a TOF PET detector is disclosed, including a direct conversion semiconductor crystal, a cathode, an anode, and photon counting circuitry. The cathode is disposed on a first face of the direct conversion semiconductor crystal. The cathode is a blocking electrode including at least one metal layer and at least one dielectric layer having an area resistance of at least 10⁷ ohm-mm² which is interposed between the at least one metal layer of the cathode and the first side of the direct conversion semiconductor crystal. The anode is disposed on a second face of the direct conversion semiconductor crystal opposite from the first face. The anode is a blocking electrode including at least one metal layer and at least one dielectric layer having an area resistance of at least 10⁷ ohm-mm² which is interposed between the at least one metal layer of the anode and the second side of the direct conversion semiconductor crystal. The photon counting circuitry is operatively connected with the direct conversion semiconductor crystal via the cathode and anode, and is configured to convert electric pulses generated by absorption of 511 keV gamma rays in the direct conversion semiconductor crystal to time stamped and position stamped radiation detection events. In some embodiments, the at least one dielectric layer of the cathode has an area resistance of 10¹¹ ohm-mm² or less, and/or the at least one dielectric layer of the anode has an area resistance of 10¹¹ ohm-mm² or less. In some embodiments, the first and second faces of the direct conversion semiconductor crystal are separated by less than 0.4 cm. In some embodiments, the anode is a pixelated anode comprising an array of anode pixels disposed on the second face of the direct conversion semiconductor crystal. In some embodiments, the TOF PET detector has timestamp jitter for the timestamped radiation events of 500 picoseconds or lower.

One advantage resides in providing a direct conversion radiation detector with sub-nanosecond timing resolution.

Another advantage resides in providing a direct conversion radiation detector with sub-nanosecond timing resolution and low dark current.

Another advantage resides in providing a direct conversion radiation detector with sub-nanosecond timing resolution and high spatial resolution.

Another advantage resides in providing a time of flight positron emission tomography (TOF PET) scanner employing direct conversion radiation detectors having one or more of the foregoing advantages.

A given embodiment may provide none, one, two, more, or all of the foregoing advantages, and/or may provide other advantages as will become apparent to one of ordinary skill in the art upon reading and understanding the present disclosure.

### BRIEF DESCRIPTION OF THE DRAWINGS

The invention may take form in various components and arrangements of components, and in various steps and arrangements of steps. The drawings are only for purposes of illustrating the preferred embodiments and are not to be construed as limiting the invention.

FIG. 1 diagrammatically illustrates a time of flight positron emission tomography (TOF PET) scanner employing direct conversion radiation detectors.

FIGS. 2 and 3 diagrammatically show two illustrative geometries for direct conversion radiation detector crystals.

FIG. 4, 5, 5A, and 6 diagrammatically show some illustrative examples of a sense circuit operatively connected to anode pixels detect an electric pulse generated by a direct conversion semiconductor crystal (FIGS. 5, 5A, and 6) and of a timing circuit operatively connected to generate a trigger signal corresponding to the detection of the electrical pulse (FIGS. 4 and 6).

FIGS. 7, 8, 9, 10, and 11 present experimental results as described herein.

### DETAILED DESCRIPTION

Attempts to achieve fast timing resolution with cadmium zinc telluride (CZT) direct conversion radiation detectors has met with limited success, with timing resolution of 2000 picoseconds or worse generally being measured. This coarse timing resolution is borderline even for conventional PET imaging, and is not sufficient for TOF PET imaging. To see this, consider that a 2000 picosecond timing resolution corresponds to a spatial localization of 60 centimeters, which is comparable to or larger than the bore diameter of a medical imaging scanner sized to perform whole-body imaging. For comparison, some state of the art TOF PET scanners exhibit 200-300 picosecond timing resolution using scintillator-based radiation detectors, corresponding to 6-9 centimeter time of flight localization. In practical terms, TOF PET image quality and dose efficiency improve quickly (approximately as the square) with timing resolution due to the reduction of source position uncertainty in the reconstruction. Timing resolution of 50 picoseconds or less would yield time of flight spatial localization along the LOR of 1.5 cm or less, and would approach the current TOF PET transverse spatial resolution of a few mm. In this regime, each measured coincidence pair indicates the spatial location in three-dimensions of the sourcing radioemission, and could enable image reconstruction by accumulation of events without iterative projection and/or error back-projection.

As disclosed herein, with certain design improvements, CZT can be expected to achieve timing resolution of 200 picoseconds or lower, and possibly as low as 50 picoseconds or lower. These improvements include a synergistic combination of employing a favorable CZT crystal geometry, and/or employing a combination of cathode timing extraction and a pixelated anode for obtaining high spatial resolution, and/or use of blocking electrode(s). The combination of these various improvements enables increased bias voltage, reduced dark current, and faster detection response time compared with existing designs.

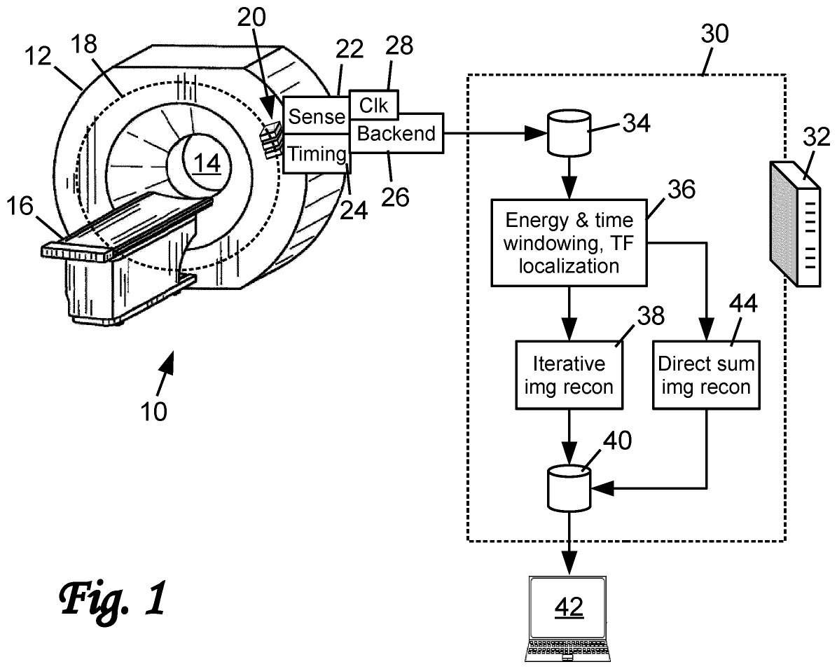

With reference to FIG. 1, a time of flight positron emission tomography (TOF PET) scanner 10 is diagrammatically shown. While the TOF PET scanner 10 is illustrated as a standalone unit, it is alternatively contemplated for the TOF PET scanner to be included in a hybrid imaging scanner, such as a hybrid computed tomography (CT)/TOF PET scanner which further includes a CT gantry (not shown). The TOF PET scanner 10 includes a TOF PET scanner housing 12 having a central bore 14 within which a patient or other imaging subject is loaded, e.g. by way of a patient couch or other patient support 16, which may optionally be robotic. One or more PET detector rings 18 (indicated diagrammatically by a dashed circle in FIG. 1) are disposed inside the housing 12 and comprise direct conversion semiconductor crystals 20 (three of which are diagrammatically indicated in FIG. 1 as examples). As further diagrammatically indicated in FIG. 1, the one or more PET detector rings 18 further include a sense circuit 22 and a timing circuit 24. The sense circuit 22 is operatively connected to detect an electric pulse generated by an electrically biased direct conversion semiconductor crystal 20 in response to absorption of a 511 keV gamma ray by the direct conversion semiconductor crystal 20. The timing circuit 24 is operatively connected to generate a trigger signal corresponding to the detection of the electrical pulse. Using designs for the direct conversion semiconductor crystal 20 as disclosed herein, the timing circuit 24 generates the trigger signal with jitter of 500 picoseconds or lower, and more preferably with jitter of 200 picoseconds or lower, and even more preferably with jitter of 50 picoseconds or lower. The trigger signal is typically a transient signal having a feature (e.g. a rising edge, a falling edge, or so forth) occurring at a time corresponding to the electrical pulse generated by the sense circuit. Backend analog or digital circuitry 26 processes the electric pulse generated by the sense circuit to generate a digital values representing the energy and position of the gamma ray that was detected by the sense circuit 22, and processes the corresponding trigger signal generated by the analog or digital timing circuit 24 to generate a digital timestamp value for the detected gamma ray. By way of non-limiting illustrative example, the backend circuitry 26 can generate the energy value by summing integrated signal or integrated energy of the electric pulse generated by the sense circuit 22 and performing analog-to-digital (A/D) conversion either before or after the summing. It can also sum multiple pixels to get the full energy of the gamma spread over many pixels and find the center of gravity or largest signal or some other feature to find the position of the gamma interaction in the detector. In a non-limiting illustrative example, the timestamp can be generated by the backend circuitry 26 using the trigger signal generated by the timing circuit 24 to trigger a read a clock 28 (which is a digital clock or an analog clock, in the latter case the triggered reading is A/D converted).

Due to the impact of signal delays, some or all of the photon counting circuitry 22, 24, 26, 28 are typically implemented as on-board analog and/or digital circuitry, that is, circuitry disposed on printed circuit boards (PCBs) or application specific integrated circuits (ASICS) forming backplanes of detector modules of the PET detector ring(s) 18 on which groups of direct conversion semiconductor crystals 20 are mounted. It is emphasized that the illustrative backend 26 is a non-limiting example, and other approaches are contemplated such as porting the analog electric pulses from the sense circuit 22 off the TOF PET scanner 10 without A/D conversion (which in such embodiments is then performed later). More generally, it will be appreciated that the backend circuitry 26 and clocking 28 can be implemented as the backend circuitry of an existing commercial TOF PET scanner with conventional scintillator-based TOF PET detectors, with adaptation to handle the particular electric pulses and trigger signals generated by the sense and timing circuitry 22, 24.

With continuing reference to FIG. 1, the output of the backend 26 comprises timestamped gamma ray detection events, which are ported off the TOF PET scanner 10 by suitable electric cabling (wireless transmission is also contemplated) and received at an electronic processor 30 (e.g. an illustrative server computer 32, and/or a dedicated TOF PET scanner computer, cluster of computers, cloud computing resource, and/or other computing system with sufficient computing capacity) and stored at a non-transitory data storage 34 included with or accessed by the electronic processor 30. The electronic processor 30 is programmed (e.g. by instructions stored on the non-transitory data storage 34 and/or other non-transitory data storage where such non-transitory data storage comprises, by way of non-limiting example, a hard disk or other magnetic storage medium, and/or an optical disk or other optical storage medium, and/or a flash memory, solid state drive, or other electronic storage medium, and/or so forth) to process the TOF PET data to generate a TOF PET image. To this end, the electronic processor 30 is programmed to perform coincidence detection processing 36 including energy, position, and time filtering and time of flight localization to generate coincidence events with time of flight localization. Each such coincidence event is defined by two detected gamma rays each having energy of about 511 keV (as defined by the applied energy window filter) and having timestamps that are coincident within the applied coincidence time window. The two coincident 511 keV gamma ray detections define a line of response (LOR) connecting the two detectors that detected the 511 keV gamma rays (e.g. the two direct conversion semiconductor crystals 20 that detected the 511 keV gamma rays, or in more spatially resolved embodiments the anode pixels of these direct conversion semiconductor crystals 20 which generated the electric pulses detected by the sense circuitry 22). For each thusly defined coincidence event, the time difference between the timestamps of the two 511 keV gamma rays is processed to determine the time of flight localization along the LOR.

With continuing reference to FIG. 1, the coincidence events output by the coincidence detection processing 36 are processed to form the TOF PET image. In a conventional approach, the electronic processor 30 is programmed to perform an iterative image reconstruction 38 employing error (back-)projection. Alternatively, the electronic processor 30 may be programmed to perform a conventional filtered backprojection image reconstruction algorithm. The resulting image is stored in a non-transitory storage medium 40, and/or displayed on a display 42 (e.g. the LCD, plasma, CRT, or other display of a computer), and/or otherwise utilized.

In a variant embodiment, if the time of flight localization has sufficient spatial resolution (e.g., if the timing resolution is 50 picoseconds or lower (or, in some more relaxed embodiments, about 50 picoseconds or lower) providing time of flight localization of about 1.5 centimeters or lower), then the conventional image reconstruction 38 can be replaced by an alternative implementation in which the electronic processor 30 is programmed to generate the TOF PET image by a summation operation 44 in which the TOF PET coincidence events are accumulated without performing an iterative image reconstruction and without performing backprojection. For example, each TOF PET coincidence event can be represented as a unit intensity value centered by the TOF localization along the line of response (LOR) connecting the two events of the coincident pair, and these unit intensity values can be accumulated over all TOF PET coincidence events to generate a TOF PET image, which may optionally be further processed, e.g. by normalizing the total integrated intensity, applying a spatial smoothing filter of dimension comparable to the TOF localization resolution (e.g., a 1.5 cm filter kernel), and/or so forth. The resulting image can again be stored in the storage 40, displayed on the display 42, and/or otherwise utilized.

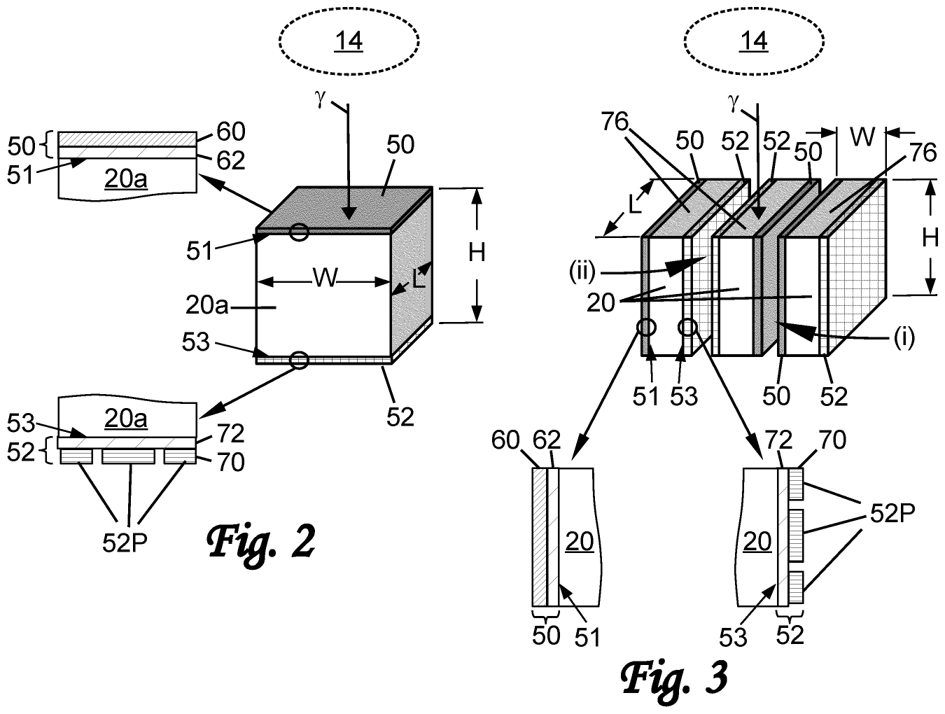

With reference now to FIGS. 2 and 3, some illustrative embodiments of the direct conversion semiconductor crystals are shown. FIG. 2 illustrates a first embodiment, in which a direct conversion semiconductor crystal 20a has a cubic geometry, or more generally, a low aspect ratio rectangular parallelepiped geometry. FIG. 3 illustrates a second embodiment, in which the direct conversion semiconductor crystal 20 has a high aspect ratio rectangular parallelepiped geometry (that is, high aspect ratio as compared with the embodiment of FIG. 2). A rectangular parallelepiped is a six-sided polyhedron in which each of the six faces is a rectangle. Note also that FIG. 2 shows a single direct conversion semiconductor crystal 20a but as noted before the PET detector ring(s) 18 include an array of such crystals, typically organized into detector modules (not shown) each hosting an N×M array of single direct conversion semiconductor crystal 20a, and the ring(s) 18 in turn being constructed as an annular assembly of such modules. FIG. 3 shows three direct conversion semiconductor crystals 20 shown in a preferred relative orientation to each other when mounted in a detector module, as will be further explained below. The dimensions of the direct conversion semiconductor crystals 20a, 20 are indicated in FIGS. 2 and 3 as dimensions L×W×H, where the dimension H is along a radiation incidence direction y as also indicated in FIGS. 2 and 3. The radiation incidence direction γ is the direction along which 511 keV gamma rays emitted by a patient or other imaging subject disposed in the central bore 14 of the TOF PET scanner 10 (see FIG. 1; more generally, the element 14 may be considered to be the examination region 14 in which the region of the imaging subject to be imaged is disposed) travel to impinge upon the direct conversion semiconductor crystal. Note that the precise direction of a given 511 keV gamma ray may deviate by up to a few degrees or perhaps up to a few tens of degrees from the indicated radiation incidence direction γ due to the finite sizes of the patient and the TOF PET detector ring(s) 18.

In the illustrative embodiments and in bench tests described herein, the direct conversion semiconductor crystal is cadmium zinc telluride (CZT). However, more generally, the direct conversion semiconductor crystal 20a or 20 may be CZT, cadmium telluride (CdTe), gallium arsenide (GaAs), mercury iodide (HgI), Perovskites, or another high-Z (i.e. high atomic number, Z) semiconductor crystal with suitable absorption and electrical characteristics for 511 keV gamma rays. The geometry of the direct conversion semiconductor crystal preferably has a thickness (dimension H in FIGS. 2-3) in the radiation incidence direction y that is sufficient to provide greater than 70% absorption of 511 keV gamma rays, which corresponds to 50% or higher efficiency for PET coincidence detection. This corresponds to a thickness of 6 mm for CZT and CdTe. A CZT crystal with 10 mm thickness will have 87% efficiency at 511 keV, and with a 15 mm thickness will be 95% efficient.

Each direct conversion semiconductor crystal 20a or 20 has a cathode 50 disposed on a first face 51 of the direct conversion semiconductor crystal and an anode 52 disposed on a second face 53 of the direct conversion semiconductor crystal opposite from the first face 51. More detailed diagrammatic cross-sectional views of the cathode 50 and anode 52 are shown as enlarged insets in FIGS. 2 and 3. As seen in these enlarged insets, each of the cathode 50 and the anode 52 is a blocking electrode formed as a metal-dielectric-semiconductor interface. The illustrative cathode is a blocking electrode which includes a metal or other electrically conductive layer 60 disposed on a dielectric layer 62 which in turn is disposed on the first face 51 of the direct conversion semiconductor crystal 20a or 20. Similarly, the illustrative anode 54 is a is a blocking electrode which includes a metal or other electrically conductive layer 70 disposed on a dielectric layer 72 which in turn is disposed on the second face 53 of the direct conversion semiconductor crystal 20a or 20. The dielectric layer 62, 72 interposes a potential barrier between the semiconductor (i.e. the direct conversion semiconductor crystal 20a or 20) and the metal electrode 60 or 70. By way of some non-limiting illustrative examples, the dielectric layer 62, 72 can be a polymer (for example, a polyimide, polyamide, Teflon, other Florine based polymer, or so forth) or a non-conducting oxide (for example, NOₓ, CdOₓ, TeOₓ, SiOₓ, Si₃N₄, non-stoichiometric SiₓN_{y}, or so forth). It is also contemplated for the dielectric layer 62 and/or the dielectric layer 72 to be a multi-layer (e.g. two-layer, three layer) stack of dielectric layers of different materials. In one illustrative example for use with CZT as the direct conversion semiconductor crystal 20a or 20, the insulating layer 62, 72 has a thickness in the range 10 nanometers to 1000 nanometers inclusive, although lesser or greater thickness is also contemplated. The choice of dielectric material and its thickness are preferably optimized for salient characteristics such as uniformity across the deposition area, adherence to the crystal 20a or 20 and to the metal 60 or 70, and electrical resistivity. In one illustrative example for use with CZT as the direct conversion semiconductor crystal 20a or 20, the electrical area resistance of the dielectric layer 62, 72 is 10⁷ ohm-mm² or higher. In another illustrative example for use with CZT as the direct conversion semiconductor crystal 20a or 20, the electrical area resistance of the dielectric layer 62, 72 is in the range 10⁷ ohm-mm² to 10¹¹ ohm-mm² inclusive. Lower or higher area resistance is also contemplated. By way of further illustrative example, CZT has resistivity of 10¹⁰ ohm-cm. The area resistance of a 1 cm thick block of CZT is then 10¹⁰ ohm-cm²(i.e., 10¹²ohm-mm²). The area resistance of the delectric layer 62, 72 should be comparable. A 1 mm thick slab would be ˜10¹¹ ohm-mm². So the expected area resistance range may be 10⁹-10¹⁴ ohm-cm² . For CdTe, the numbers would be 0.1 smaller. The electrical area resistance of the dielectric layer 62, 72 is preferably chosen to limit injected dark currents from the electrodes (cathode 50 or anode 60) under a high applied bias voltage, and simultaneously to allow photocurrent to flow out of the direct conversion semiconductor crystal 20a or 20. As one specific example for use with CZT as the direct conversion semiconductor crystal 20a or 20, the dielectric layer 62, 72 is a SiO₂ layer of thickness 10 nm, which provides an area resistance of 10⁹ ohm-mm². The insulating layer 62, 72 can be formed using any thin film deposition or formation methodology, such as sputter deposition, or deposition by vacuum evaporation, deposition by spin coating, thermal growth of a native oxide (e.g. CdOₓ), or so forth. The metal layers 60, 70 can in general comprise any electrically conductive metal that adheres adequately to the underlying dielectric layer 62, 72 with some suitable metals including gold, silver, copper, alloys thereof, and/or so forth. The metal layer 60 (and/or metal layer 70) may also comprise a stack of two or more different metal layers (e.g. a nickel/gold metal layer stack). It will also be appreciated that thin (e.g. monolayer or several monolayer) transitional layers may be provided to enhance adhesion, smoothness, or for other reasons.

Furthermore, while the illustrative examples are metal/dielectric/semiconductor blocking junctions, in an alternative approach the blocking contacts can be fabricated as junction effect blocking contacts (e.g. Schottky barrier contacts). Best results (e.g. lowest dark current, highest achievable bias voltage) is expected when both the cathode 50 and the anode 52 are blocking electrodes. However, in variant embodiments, it is contemplated for only one of these (e.g. the cathode 60 but not the anode) to be a blocking electrode.

With continuing reference to FIGS. 2 and 3, the illustrative anode 52 is a pixelated anode; that is, the anode 52 comprises an array of electrode pixels (or anode pixels) 52P disposed on the second face of the direct conversion semiconductor crystal. In the illustrative example, the anode pixels 52P are defined by patterning of the electrically conductive layer 70, while the underlying dielectric layer 72 is continuous and extends between the pixels 52P. This does not create electrical shunting between the pixels as dielectric layer 72 is electrically insulating, i.e. electrically non-conductive. In an alternative embodiment, the anode pixels are defined by patterning both layers 70, 72. The cathode 60, by contrast, is a continuous electrode extending over much or all of the first face 51 of the direct conversion semiconductor crystal 20a or 20. Small anodes pixels advantageously provide higher spatial resolution; however, attempting to extract the timing signal from a pixelated electrode can degrade the timing resolution. See related discussion below referencing FIGS. 5 and 6. In approaches disclosed herein, it is disclosed to extract the timing signal from the large-area cathode 50 and the spatial localization information (on the detector face) from the pixelated anode 52. This approach takes advantage of the low flux (i.e. low counts) encountered in PET as compared with an imaging modality such as CT which must be capable of detecting a continuous and high flux (i.e. beam) of X-rays.

With continuing reference to FIGS. 2 and 3, the low aspect ratio geometry of the embodiment of FIG. 2 has certain disadvantages compared with the high aspect ratio geometry of FIG. 3. As previously noted, the “depth” dimension H must be large enough to provide the desired fractional absorption of 511 keV gamma rays. In some embodiments employing CZT, the depth H is preferably at least 0.8 cm. With the cathode 50 and anode 52 on the top and bottom faces of the crystal 20a, this imposes a minimum separation of 0.8 cm between the electrodes 50, 52. The electric field (assuming it is uniform through the crystal) is given by the voltage divided by the thickness, and so a larger separation translates to a smaller electric field, which reduces the device speed (relating to timing resolution) for a given applied high voltage (HV). The difficulty, risk of failure, and cost of HV engineering all rise quickly with the applied HV level. By comparison, in the high aspect ratio embodiment of FIG. 3, the cathode 50 and anode 52 are disposed on the two opposing “sides” of the direct conversion semiconductor crystal 20, and a radiation receiving face 76 extends between the first and second faces 51, 53. The direct conversion semiconductor crystal 20 is mounted in the TOF PET scanner housing 12 (see FIG. 1) with the radiation receiving face 76 arranged to receive 511 keV gamma rays emanating from the central bore along the radiation incidence direction γ. In this case, the depth dimension H does not extend between the electrodes 50, 52; rather, the separation between the cathode 50 and anode 52 is the dimension W, which can be made smaller than the depth H. For example, in some embodiments the first and second faces 51, 53 of the direct conversion semiconductor crystal 20 are separated by less than 0.4 cm, i.e. the dimension W is less than 0.4 cm (although larger values for W is also contemplated). The third dimension, labeled as L in the drawings, can be made large so that the area of the cathode (corresponding to the area L×H) can be made large. Making the third dimension L large also reduces the number of crystals 20 needed to cover a specified area, as the area of the radiation receiving face 76 is L×W. Hence, a high aspect ratio design in which dimension W is significantly smaller than the dimensions L and H has the advantages of providing the desired radiation absorption thickness (via large dimension H) and a higher electric field for a given bias voltage across the electrodes 50, 52 (due to the smaller separation W between these electrodes), with the large third dimension L also providing large area for the first and second faces 51, 53 (and hence large-area cathode 50 and large area covered by anode pixels 52P).

In the design for the embodiment of FIG. 3, the direct conversion semiconductor crystal 20 has the radiation receiving face 76 extending between the first and second faces 51, 53. The first and second faces 51, 53 are mutually parallel and each have an area of dimensions L×H. The radiation receiving face 76 has an area of dimensions L×W. The first face 51 and the radiation receiving face 76 meet at an edge of length L, and the second face 53 and the radiation receiving face 76 also meet at an edge of length L. In some such embodiments, the dimension H (i.e. the dimension along the radiation incidence direction γ) is at least three times larger than W, although a smaller aspect ratio is also contemplated. In some such embodiments, the direct conversion semiconductor crystal 20 is cadmium zinc telluride (CZT) and the dimension H is at least 0.8 cm.

With particular reference to FIG. 3, one possible issue with this design is that the electrode of each direct conversion semiconductor crystal 20 is positioned in close proximity to the electrode of the next-neighboring crystal 20. If the anodes are grounded and the cathodes are held at a bias voltage—V, then if an anode 52 of one crystal 20 is thusly arranged in close proximity to a cathode 50 of the next-neighboring crystal 20 this will result in the entire bias voltage magnitude |V| being applied across the gap between the two crystals. This gap is preferably small since the gap represents a region in which 511 keV gamma rays cannot be detected. With the gap being small, the electric field (equal to |V| divided by the gap distance) is large, and can possibly result in arcing and/or breakdown over time of any spacing material interposed between the adjacent crystals 20. In the arrangement shown in FIG. 3, this issue is addressed by arranging the direct conversion semiconductor crystals 20 with each neighboring pair of direct conversion semiconductor crystals 20 positioned with one of (i) their respective cathodes 50 facing each other or (ii) their respective anodes 52 facing each other. The case of facing cathodes is indicated by reference label (i) in FIG. 3, while the case of facing anodes is indicated by reference label (ii) in FIG. 3. It will be appreciated that this alternating orientation of crystals 20 can be repeated indefinitely, i.e. as:

. . . CXA AXC CXA AXC CXA AXC CXA AXC CXA AXC CXA AXC . . .

where in the above diagrammatic notation “X” represents a crystal 20, “C” represents the cathode 50 of the crystal, “A” represents the anode 52 of the crystal, “CXA” then represents a crystal in one orientation, and “AXC” represents a crystal in the opposite orientation. In every instance, cathode faces cathode and anode faces anode, and there is no large voltage imposed across any gap between adjacent crystals. Another contemplated advantage of this design is the restriction of the range of the photoelectron (the first product of the x-ray absorption) and all secondary electrons in the dimension W. This would reduce the task of integrating large volumes of the semiconductor to obtain the energy signals in electronics, firmware and software. In a variant embodiment, an electrically insulating spacer, such as a Kapton sheet (insults to greater than 3 kilovolts) may be inserted between adjacent crystals. Denoting the capton sheet as “K”, the above arrangement can then be written as:

. . . CXA K AXC K CXA K AXC K CXA K AXC K CXA K AXC K CXA K AXC . . .

If the insulation provided by the Kapton sheet or other insulator is sufficient, then the alternating orientation arrangement can be replaced by a non-alternating orientation arrangement, i.e.:

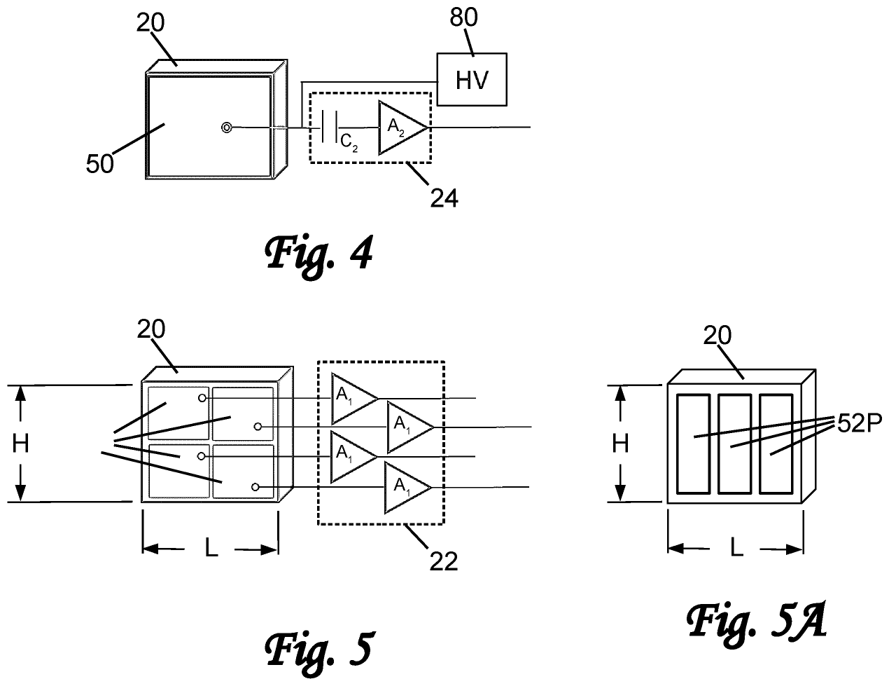

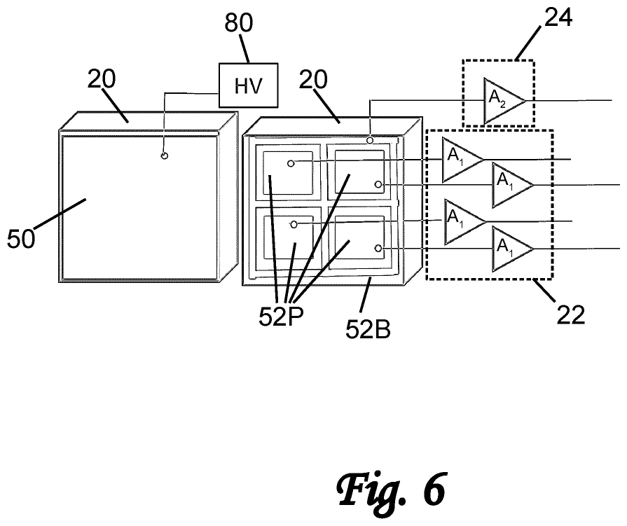

. . . CXA K CXA K CXA K CXA K CXA K CXA K CXA K CXA K CXA K CXA . . . With reference now to FIGS. 4 and 5, an illustrative example of the sense circuit 22 (FIG. 5), the timing circuit 24 (FIG. 4), and a biasing circuit 80 (FIG. 4) is shown in conjunction with the large aspect ratio direct conversion semiconductor crystal 20 of FIG. 3. The bias circuit 80 applies a large (negative) bias to the cathode 50, while the anode 52 is preferably grounded (not shown). The biasing circuit 80 can therefore be implemented as a DC power supply outputting a high (negative) voltage respective to ground. Coupling circuit elements such as an intervening resistor (not shown) may also be employed in the biasing circuit 80. The sense circuit 22 is shown in FIG. 5, and connects with the anode pixels 52P. The timing circuit 24 is shown in FIG. 4, and connects with the cathode 50.

With regards to the illustrative sense circuit 22 of FIG. 5, the pixelated anode permits the location of arrival of 511 keV gamma rays to be determined with higher spatial resolution (as compared with the anode being a continuous large-area electrode coextensive with the area of the second face 53). In general, using a higher number of smaller anode pixels provides higher spatial resolution, but at the possible cost of that many pixels are summed together to obtain the full energy of the detected gamma ray. The energy of a 511 keV gamma ray is distributed across many millimeters, and even centimeters. As seen in FIG. 5, each anode pixel 52P is read by a corresponding amplifier (A₁) which may for example be implemented as an operational amplifier (op amp) circuit. Amplifier noise of the amplifiers (A₁) is preferably less than 10000 electrons in some embodiments. The amplifiers (A₁) may be either ac or dc coupled.

With continuing reference to FIG. 5 and with further reference briefly to FIG. 5A, it will be recognized that a higher linear density of the anode pixels 52P along the depth dimension H increases the depth of interaction (DOI) resolution; whereas, a higher linear density of the anode pixels 52P along the lateral dimension L increases the lateral resolution. (Lateral resolution in the lateral direction orthogonal to dimension H is determined by the third dimension W of the crystal 20 which separates the electrodes 50, 52—this third dimension is advantageously made smaller so as to achieve higher electric field for a given bias voltage as already discussed, but being smaller also improves lateral spatial resolution in that lateral direction by limiting the range of primary and secondary electrons). With brief reference to FIG. 5A, in a variant embodiment, if the spatial resolution in the DOI direction is not deemed important (e.g., no DOI information is to be extracted), then it is contemplated to employ a linear array of high aspect ratio anode pixels 52P as shown in FIG. 5A, in which each anode pixel has its long dimension parallel with the dimension H (and optionally co-extensive with the second face 53 along the dimension H) and its short dimension parallel with the dimension L. In the approach of FIG. 5A, no DOI information is provided, but improved spatial resolution along the lateral direction parallel with dimension L is provided to find the center of gravity of the charge produced by the absorbed x-ray.

In another variant (not shown), the cathode may be pixelated while the anode is a continuous electrode. In this case, the sense circuit 22 is suitably connected with the pixelated cathode, while the timing circuit 24 is connected to the continuous anode. More generally, the timing circuit is connected with the continuous electrode (be it the cathode, as shown, or the anode) and the position sense circuit is connected with the pixelated electrode (be it the anode, as shown, or the cathode).

Turning to the illustrative timing circuit 24 of FIG. 4, this may be suitably implemented by an amplifier circuit including an amplifier (A₂) and a capacitor (C₂) which generates a transient signal having a feature (e.g. a rising edge, a falling edge, or so forth) occurring at a time corresponding to the electrical pulse generated by the sense circuit 22. In one suitable embodiment, the timing circuit 24 is at low voltage in its quiescent state, achieved using AC coupling. The slew rate of the amplifier (A₂) should be fast enough to avoid undesirable limitation on the temporal resolution of the generated timing signal—in some illustrative embodiments, the amplifier slew rate is faster than one nanosecond.

It will be appreciated that the transient signal generated by the timing circuit 24 also provides spatial information regarding the location of the 511 keV gamma ray detection, albeit with resolution of only H×L corresponding to the area of the crystal 20 covered by the cathode 50. If this spatial resolution is deemed sufficient (for example, if the dimension L is sufficiently small and DOI information is to be disregarded), then the transient signal generated by the timing circuit 24 can also serve as the sense signal, in which case the separate sense circuit 22 is suitably omitted. In such embodiments, the anode 52 is suitable a continuous large area electrode having an area comparable or equal to the area of the cathode 50. In that case also either the anode or the cathode can be used for position or for timing or for both functions.

With reference to FIG. 6, in a variant embodiment both the sense circuit 22 and the timing circuit 24 connect with the anode (while the bias circuit 80 still applies the negative bias voltage to the cathode 50). To avoid loss of timing resolution due to the small anode pixel effect, the anode in this case comprises an array of anode pixels 52P surrounded by a border electrode 52B which connectively surrounds all the areas containing the anode pixels 52P. The amplifiers (Ai) of the sense circuit 22 read out individual anode pixels 52P as already described with reference to FIG. 5. The timing circuit 24, however, is connected with the border electrode 52B in the embodiment of FIG. 6.

In general, the sense and timing circuits 22, 24 may be analog circuits, digital circuits (with A/D input), or hybrid or mixed analog/digital circuitry; may employ parallel and/or pipelined structures; may employ discreet components and/or application-specific integrated circuit (ASIC) components; may use various circuit component configurations such as flipchip or proximal components; and may be bonded by conductive glue or soldered or so forth. The timing circuit 24 should have slew rates fast enough to measure signals of the desired speed, e.g. signals of 20FC/200ns in some non-limiting illustrative examples (where this is estimated from the charge of a 511 keV gamma photon transiting a 1 cm detector driven by an electric field of about 500V/mm and an electron mobility in the crystal 20 of about 1000 cm2/V-s).

To demonstrate the timing resolution achievable by the disclosed approaches, devices of the type shown in FIG. 3 were bench tested. The devices employed CZT as the direct conversion semiconductor crystal, combining the large aspect ratio geometry of the direct conversion semiconductor crystals 20 of FIG. 3 with the direction of incidence through the cathode as in FIG. 2. The dimensions L and H were 20 mm and 10 mm whereas the dimension W was 2 mm, with reduced absorption than the >0.4 mm discussed above. The devices were tested with a bias of 900V applied between the cathode and anode, giving 450 V/mm, which is close to the 500V/mm discussed above and with correct dark currents, dark current generated noise, and signal risetimes. In the bench tests, the timing circuit 24 was operatively connected to generate a trigger signal in response to absorption of high energy keV gamma ray by the direct conversion semiconductor crystal. In the test setup Co57 was used to output 350 to 700 keV gamma rays as this range overlaps the 511 keV gamma ray from electron-positron annihilation emitted during PET imaging. In the bench tests, the timing circuit generated the trigger signal with jitter of 500 picoseconds, corresponding to time of flight localization of the coincidence event along the line of response (LOR) having spatial resolution of 15 cm. This is sufficient to provide useful time of flight information for use in TOF PET image reconstruction. Analysis of the jitter measurements showed that the measured jitter was limited by the amplifier used in the timing measurement circuit, and based on analysis of these test results it is believed that devices can provide TOF PET timing resolution of 200-300 picoseconds comparable with current state of the art scintillator-based TOF PET detectors, or better. Further tailoring of the electronic conditioning circuit, the detector geometry as disclosed herein, and blocking contacts as described herein is expected to achieve still lower timing resolution, e.g. 50 picoseconds or lower timing resolution. This would correspond to a spatial resolution of 1.5 cm, which is sufficient to enable a TOF PET image by accumulating the TOF PET coincidence events without performing an iterative image reconstruction and without performing backprojection.

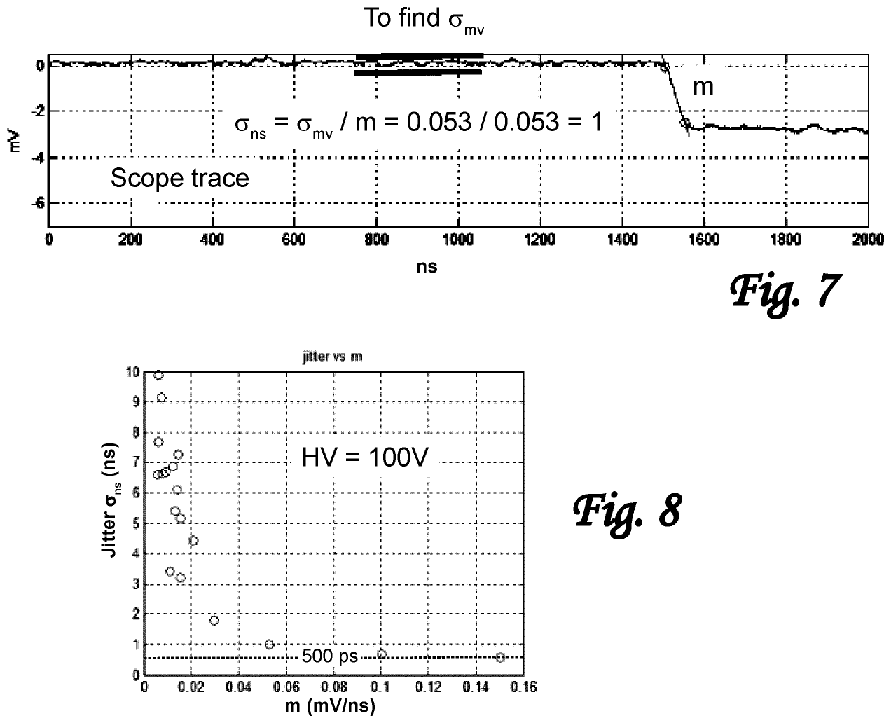

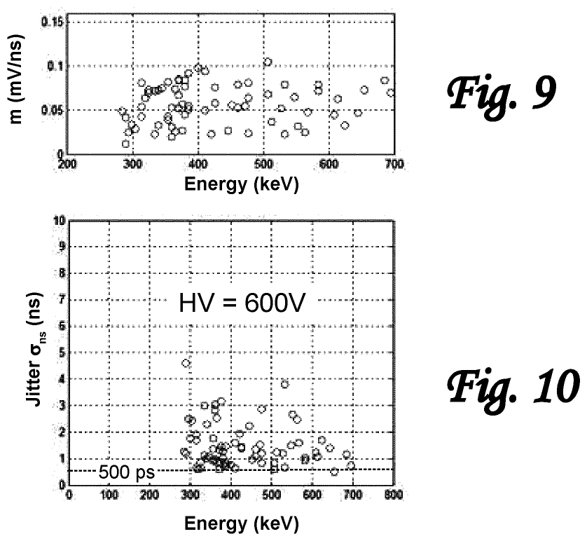

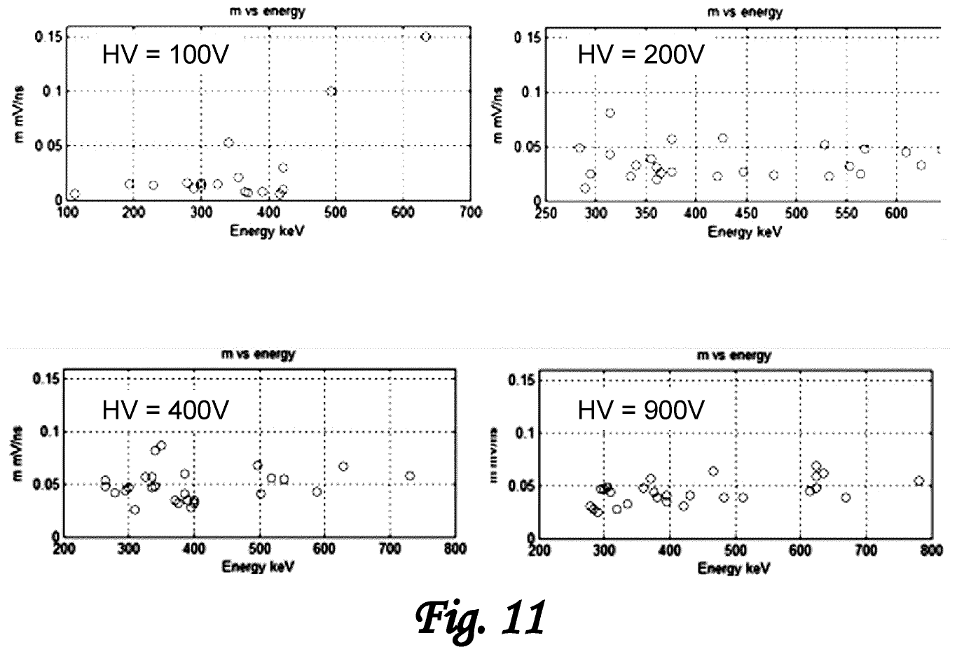

FIGS. 7-11 illustrate some experimental results. The combination of high blocking contacts and timing electronics was tested to see if the time jitter showed the improvement necessary to become useful for TOF PET. A slab of CZT with the geometry of FIG. 3 was placed in a sample holder. A timing circuit similar to that shown in FIG. 4 was connected to the cathode and the anodes were all connected to ground. A commercial Ortec 142A charge sensitive preamplifier with slew rate=7.5 ns (60pF) was used. The HV was ramped up to 450V/mm. X-ray photons (i.e. gamma rays) of 350 to 700 keV were provided to the cathode surface as illustrated in FIG. 2. Signal traces were recorded on a digital oscilloscope as shown in FIG. 7, and the digital traces were transferred to a computer for analysis. The baseline and baseline noise (σₘᵥ) were determined on the computer using the mean and rms functions, as indicated in FIG. 7. The slope (m) of the signal rise was determined from the 10%, 90% points on the rise, as further indicated in FIG. 7. The timing jitter (σₙₛ) was determined from the slope/(baseline noise). Many traces with HV=100V were analyzed, and the jitter vs slope are plotted in FIG. 8. The traces with the highest slopes, representing the high energy photons near 700 keV showed jitter as little as 500 ps (i.e. 0.5 nanoseconds). For the experiments described with reference to FIGS. 9 and 10, the HV was increased to 600V and more traces were acquired and analyzed, and the results are shown in FIGS. 9 and 10. Values of time jitter (σₙₛ) as small as 500 ps were seen again, as shown in FIG. 10. However, the higher HV (600 V) did not show further decreased jitter values nor higher values of slope (m) as expected (see FIG. 9). FIG. 11 shows that the limitation is derived from the amplifier; the rise slope increases from 100 to 200 to 400 V, but not any further for 900 V. Thus it was concluded that the amplifier slew rate is limiting the measurement, and that the jitter would be even lower than 500 ns with a faster amplifier. It was projected that a 10× faster amplifier with slew rate=0.75 ns would bring the measurement to jitter=50 ps.

The invention has been described with reference to the preferred embodiments. Modifications and alterations may occur to others upon reading and understanding the preceding detailed description. It is intended that the exemplary embodiment be construed as including all such modifications and alterations insofar as they come within the scope of the appended claims or the equivalents thereof.

1. A time of flight positron emission tomography (TOF PET) detector comprising:
a direct conversion semiconductor crystal;
a cathode disposed on a first face of the direct conversion semiconductor crystal;
an anode disposed on a second face of the direct conversion semiconductor crystal opposite from the first face; and
a timing circuit operatively connected to generate a trigger signal in response to absorption of a 511 keV gamma ray by the direct conversion semiconductor crystal, wherein the timing circuit generates the trigger signal with jitter of 500 picoseconds or lower.

2. The TOF PET detector of claim 1 further comprising:
a TOF PET scanner housing having a central bore,
wherein the direct conversion semiconductor crystal further has a radiation receiving face extending between the first and second faces, and the direct conversion semiconductor crystal is mounted in the TOF PET scanner housing with the radiation receiving face arranged to receive 511 keV gamma rays emanating from the central bore.

3. The TOF PET detector of claim 1 wherein:
the direct conversion semiconductor crystal further has a radiation receiving face extending between the first and second faces, and
the first and second faces are mutually parallel and each have an area of dimensions L×H, and
the radiation receiving face has an area of dimensions L×W, and
the first face and the radiation receiving face meet at an edge of length L; and
the second face and the radiation receiving face meet at an edge of length L; and
H is at least three times larger than W.

4. The TOF PET detector of claim 3 wherein the direct conversion semiconductor crystal is cadmium zinc telluride and H is at least 0.8 cm.

5. The TOF PET detector of claim 1 wherein the direct conversion semiconductor crystal is a rectangular parallelepiped of dimensions L×W×H.

6. The TOF PET detector of claim 1 comprising:
a plurality of said direct conversion semiconductor crystals, arranged with each neighboring pair of direct conversion semiconductor crystals positioned with one of (i) their respective cathodes facing each other or (ii) their respective anodes facing each other.

7. The TOF PET detector of any claim 1 wherein at least one of the cathode and the anode comprises a blocking electrode.

8. The TOF PET detector of claim 1 wherein:
the cathode comprises at least one metal layer and at least one dielectric layer which is interposed between the at least one metal layer of the cathode and the first side of the direct conversion semiconductor crystal; and
the anode comprises at least one metal layer and at least one dielectric layer which is interposed between the at least one metal layer of the anode and the second side of the direct conversion semiconductor crystal.

9. The TOF PET detector of claim 8 wherein the dielectric layer of the cathode comprises an oxide having a thickness in the range 10 nm to 1000 nm inclusive and the dielectric layer of the anode comprises an oxide having a thickness in the range 10 nm to 1000 nm inclusive.

10. The TOF PET detector of claim 8 wherein the at least one dielectric layer of the cathode has an area resistance in the range 10⁷ ohm-mm² to 10¹¹ ohm-mm² inclusive and the at least one dielectric layer of the anode has an area resistance in the range 10⁷ ohm-mm² to 10¹¹ ohm-mm² inclusive.

11. The TOF PET detector of claim 10 further comprising:
a sense circuit operatively connected to detect an electric pulse generated by the direct conversion semiconductor crystal in response to absorption of a 511 keV gamma ray by the direct conversion semiconductor crystal;
wherein the cathode is a single continuous electrode disposed on the first face of the direct conversion semiconductor crystal, and the timing circuit is operatively connected with the cathode; and
the anode comprises an array of electrode pixels disposed on the second face of the direct conversion semiconductor crystal, and the sense circuit is operatively connected with the electrode pixels of the anode.

12. The TOF PET detector of claim 1 wherein the direct conversion semiconductor crystal is a cadmium telluride (CdTe) or cadmium zinc telluride (CZT) crystal.

13. The TOF PET detector of claim 1 wherein the timing circuit generates the trigger signal with jitter of 50 picoseconds or lower.

14. A TOF PET scanner comprising:
one or more PET detector rings comprising TOF PET detectors as set forth in claim 13; and
an electronic processor programmed to generate TOF PET coincidence events with time of flight localization determined based on the trigger signals generated by the timing circuits (24) of the TOF PET detectors.

15. The TOF PET scanner of claim 14 wherein the electronic processor is further programmed to generate a TOF PET image by accumulating the TOF PET coincidence events without performing an iterative image reconstruction and without performing backprojection.

16. A time of flight positron emission tomography (TOF PET) detection method comprising:
detecting 511 keV gamma rays using a direct conversion semiconductor crystal biased via a cathode disposed on a first face of the direct conversion semiconductor crystal and an anode disposed on a second face of the direct conversion semiconductor crystal opposite from the first face;
generating trigger signals having jitter of 500 picoseconds or lower corresponding to the detected 511 keV gamma rays using a timing circuit operatively connected with the direct conversion semiconductor crystal.

17. The TOF PET detection method of claim 16 wherein the cathode is a single continuous electrode disposed on the first face of the direct conversion semiconductor crystal, and the timing circuit is operatively connected with the cathode.

18. The TOF PET detection method of claim 16 wherein the anode comprises an array of electrode pixels disposed on the second face of the direct conversion semiconductor crystal, and the detecting comprises spatially localizing the 511 keV gamma rays based on signals detected by the electrode pixels of the anode.

19. A time of flight positron emission tomography (TOF PET) detector comprising:
a direct conversion semiconductor crystal;
a cathode disposed on a first face of the direct conversion semiconductor crystal, the cathode being a blocking electrode including at least one metal layer and at least one dielectric layer having an area resistance of at least 10⁷ ohm-mm² which is interposed between the at least one metal layer of the cathode and the first side of the direct conversion semiconductor crystal;
an anode disposed on a second face of the direct conversion semiconductor crystal opposite from the first face, the anode being a blocking electrode including at least one metal layer and at least one dielectric layer having an area resistance of at least 10⁷ ohm-mm² which is interposed between the at least one metal layer of the anode and the second side of the direct conversion semiconductor crystal; and
photon counting circuitry operatively connected with the direct conversion semiconductor crystal via the cathode and anode and configured to convert electric pulses generated by absorption of 511 keV gamma rays in the direct conversion semiconductor crystal to timestamped and position-stamped radiation detection events.

20. The TOF PET detector of claim 19 wherein the first and second faces of the direct conversion semiconductor crystal are separated by less than 0.4 cm.
